(19) United States
(12) Patent Application Publication
(10) Pub. No.: US 2004/0260678 A1
(43) Pub. Date: Dec. 23, 2004

(54) State based configuration failure detection using checkpoint comparison

(75) Inventors: Chad Verbowski, Redmond, WA (US); Yi-Min Wang, Bellevue, WA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Microsoft Corporation, Redmond, WA

(21) Appl. No.: 10/464,118

(22) Filed: Jun. 18, 2003

(51) Int. Cl. G06F 17/30

(52) U.S. Cl. 707/3

(57) ABSTRACT

A system and method for determining configuration failure root cause of an application uses persistent-state checkpoints. Checkpoints are periodic snapshots of configuration data saved at different points in a machine's history. One component in the system compares checkpoints, records configuration file accesses, and tracks change frequencies of configuration file values. Another component is configured to record actions of a user interface and configuration file modifications and to search one or more databases for information related to the configuration failure. The components determine a deviation from known operation of the application without the application specifying configuration settings that control the deviation. The method includes identifying a set of configuration data modified since a last known working state of the application, intersecting the set of configuration data with data associated with access by the application, removing frequently changing configuration data from the intersection, and ranking each entry by likelihood of each entry being the cause of the failure.

### FIELD OF THE INVENTION

This invention relates generally to computer systems and, more particularly, relates to improvements in reliability, manageability, and serviceability of computer systems and software.

### BACKGROUND OF THE INVENTION

Application software reliability is a very important issue for computer users. Repairing software that “was working yesterday” has been a common complaint of computer users since the vacuum tubes of ENIAC first warmed up. Often these types of software problems have as the root cause a very complex interaction between multiple programs.

Present day operating systems often store a great deal of configuration and state information in non-volatile memory, which is necessary to allow the high degree of flexibility these systems have achieved. Applications and driver software often must read this information to ascertain the environment under which the application is operating as well as write this configuration information to alter this environment to perform user specified functions. One example of such a file in which configuration information is stored is the Windows Registry files. It is not uncommon for these files to hold 300,000 separate entries. As multiple programs often provided by many vendors and users must have access to and change this information, it is inevitable that conflicts will arise. It is not uncommon for a user to change a group of settings and not even realize that they have changed a setting in a configuration file. A week later, the user may run an application that will not function properly with the new setting. At this point the user has little chance of realizing that the two events are related.

What is needed is a system and method capable of discovering and correcting configuration conflicts efficiently and independent of significant user interaction.

### BRIEF SUMMARY OF THE INVENTION

A system and method for determining configuration failure root cause of an application uses persistent-state checkpoints. Checkpoints are a backup of all configuration data and configuration files saved at different points in a machine's history. One component in the system compares checkpoints, records configuration data accesses, and tracks change frequencies of configuration values. Another component is configured to record actions of a user interface and configuration modifications and to search one or more databases for information related to the configuration failure. The components determine a deviation from known operation of the application without the application specifying configuration settings that control the deviation.

An embodiment for a method includes identifying a set of configuration data modified since a last known working state of the application, intersecting the set of configuration data with data associated with access by the application, removing frequently changing configuration data from the intersection, and ranking each entry by likelihood of each entry being the cause of the failure.

The system and methods compare a present configuration file to a checkpoint, to narrow the search to only those registry values that have changed. According to the method, a log is maintained including values used by the application. The method optionally uses the Internet to search documentation and databases related to the application to ascertain what entries in the configuration table have caused the highest frequency of reported problems with the application in question. Finally, the configuration file on the local machine is compared to that on computers on which the application in question is functional. Additional features and advantages of the invention will be made apparent from the following detailed description of illustrative embodiments, which proceeds with reference to the accompanying figures.

### BRIEF DESCRIPTION OF THE DRAWINGS

While the appended claims set forth the features of the present invention with particularity, the invention, together with its objects and advantages, can be best understood from the following detailed description taken in conjunction with the accompanying drawings of which:

FIG. 1 is a block diagram generally illustrating an exemplary computer system in accordance with an embodiment of the present invention.

FIG. 2 is flow chart illustrating a state-based approach to ascertaining the cause of application failures in accordance with an embodiment of the present invention.

FIG. 3 is a block diagram of a state-based approach to ascertaining the cause of application failures in accordance with an embodiment of the present invention.

FIG. 4 is a flow diagram illustrating a method in accordance with an embodiment of the present invention.

FIG. 5 is a block diagram illustrating an exemplary system implementing embodiments of the present invention.

FIG. 6 is a flow diagram illustrating a method in accordance with an embodiment of the present invention.

### DETAILED DESCRIPTION OF THE INVENTION

Turning to the drawings, wherein like reference numerals refer to like elements, the invention is illustrated as being implemented in a suitable computing environment. Although not required, the invention will be described in the general context of computer-executable instructions, such as program modules, being executed by a personal computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multi-processor systems, microprocessor based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

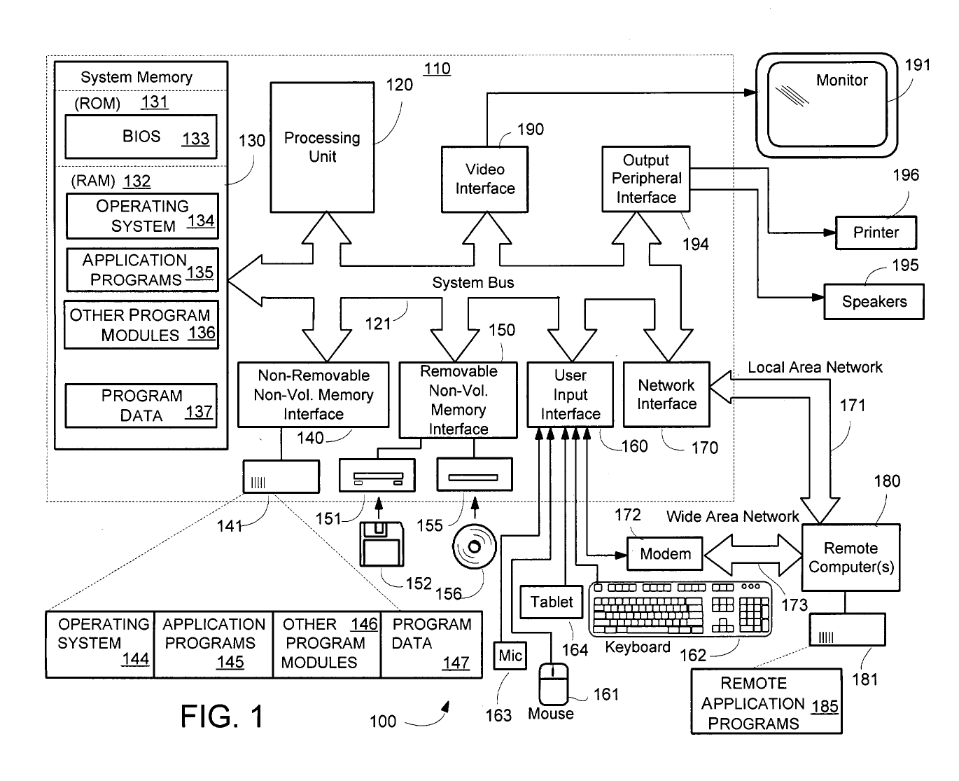

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention includes a general purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 typically includes a variety of computer readable media. Computer readable media can be any available media that can be accessed by the computer 110 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136 and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146 and program data 147. Note that these components can either be the same as or different from operating system 134, application programs 135, other program modules 136, and program data 137. Operating system 144, application programs 145, other program modules 146, and program data 147 are given different numbers hereto illustrate that, at a minimum, they are different copies. A user may enter commands and information into the computer 110 through input devices such as a tablet/electronic digitizer 164, a microphone 163, a keyboard 162 and pointing device 161, commonly referred to as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. The monitor 191 may also be integrated with a touch-screen panel or the like. Note that the monitor and/or touch screen panel can be physically coupled to a housing in which the computing device 110 is incorporated, such as in a tablet-type personal computer. In addition, computers such as the computing device 110 may also include other peripheral output devices such as speakers 197 and printer 196, which may be connected through an output peripheral interface 194 or the like.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet. For example, in the present invention, the computer system 110 may comprise the source machine from which data is being migrated, and the remote computer 180 may comprise the destination machine. Note however that source and destination machines need not be connected by a network or any other means, but instead, data may be migrated via any media capable of being written by the source platform and read by the destination platform or platforms.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

In the description that follows, the invention will be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer, which reconfigures or otherwise alters the operation of the computer in a manner well understood by those skilled in the art. The data structures where data is maintained are physical locations of the memory that have particular properties defined by the format of the data. However, while the invention is being described in the foregoing context, it is not meant to be limiting as those of skill in the art will appreciate that various of the acts and operation described hereinafter may also be implemented in hardware.

A program execution starts by creating a process from binary executables, reading configuration data from persistent storage, and accessing volatile resources (e.g., CPU, memory, etc.) provided by the operating system. The execution can fail due to faults in any of these components. Failed program executions caused by Bohrbugs (i.e., software faults that deterministically result in failures) can only be repaired through debugging and removal of the defects. Failed executions caused by Heisenbugs (i.e. somewhat random changes in the volatile resources) can often be repaired by restarting the program or rebooting the machine to provide a different volatile resource environment. In between is a class of software failures caused by configuration problems: they failed deterministically across restarts, but they can be repaired through the correction of the configuration problems, without modifying the program executable. These types of failures are relatively common and finding the cause of these failures is an area in which software can be devised to aid to the search for the root cause of the failure.

For purposes of the present disclosure the following terminology applies: a “configuration fault” refers to a piece of faulty configuration data; a “configuration error” is the manifestation of a configuration fault that causes the program state to deviate from the correct one; the error may eventually result in a “configuration failure” when the incorrect state results in an externally observable symptom such as an error dialog box or failure to deliver the expected service. These types of faults often manifest in an application which seemingly stops functioning properly. These failures are often caused by modifications to configuration data that either are not intentionally made by the users or are side effects of some intentional configuration tasks not well-understood by the users. For example, downloading a Web component, installing an application, hardware or device driver, executing a normal or malicious program, accidentally clicking mouse buttons, and many other actions can potentially make such modifications. Configuration failures are particularly hard to diagnose when they are caused by latent errors or when the faults reside in shared configuration data such as network devices, Internet applications, and display settings that are not intuitively tied to the failing applications.

When users encounter such failures, they usually perform symptom-based troubleshooting consisting of two phases, which can be implemented iteratively: the narrow-down phase in which users try to match the symptoms against their past experiences and try various configuration tasks based on their knowledge of the applications to narrow down the problems to a small list of candidates, and then the solution-query phase in which they try to search the product-support database or the Web for information and solutions to similar existing problems. The effectiveness of this approach is highly variable because it relies on the users' interpretations and descriptions of the symptoms and the choices of search strings. It is particularly ineffective for newly released operating system versions as it takes time to build up the knowledge. Therefore, a need exists for software which can aid the user by searching the configuration data for the configuration fault or at least narrow the large base of configuration data to a more manageable list of likely candidates that may be the source of the configuration fault.

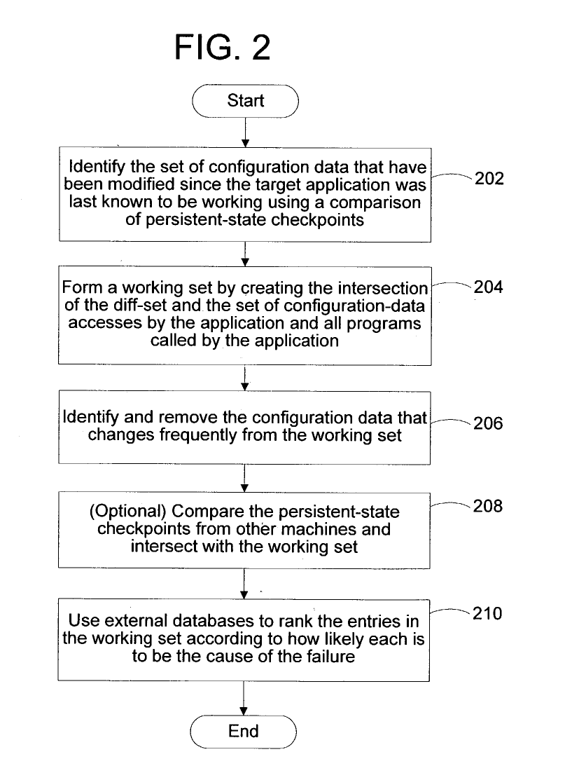

Turning to FIG. 2, a block diagram 200 of a state-based approach to finding configuration failures is illustrated. Block 202 provides for using a comparison of persistent-state checkpoints to identify the set of configuration data that have been modified since the target application was last known to be working. A persistent-state checkpoint is any configuration data that is saved at different points in history, often but not necessarily on a periodic basis. For example, in the Windows XP operating system, a copy of the Registry is saved every 24 hours by default. Any potential configuration fault must be captured by the set of configuration data that has been modified between checkpoints. By selecting a checkpoint from the day that the problem did not exist, and selecting a checkpoint for the day that the problem did exist it is possible to compare these two checkpoints to determine the set of configuration entries that have changed. This set is referred to as the diff-set. In block 204, the intersection of the diff-set and the set of configuration-data accesses by the application and all programs called by the application is created to form a working set. As one of skill in the art will appreciate, there are other sets of data that can be used to create either a larger or smaller set of data to examine depending on system requirements and the problems to be solved. One such other set of data could be a slightly larger set than the working set, but could be more efficient because it is easily obtainable. For example, the set of all configuration data accessed by the entire application execution including application launching from a predetermined point in the execution of the application until the failure occurs. The working set further limits the possible cause of the failure because only the configuration data that is accessed by the application and the programs it calls and that has also changed could cause the failure. Block 206 provides that the configuration data that changes frequently is identified and removed from the working set. This is based on the observation that data that changes frequently usually does so by design and it is unlikely that applications would be sensitive to changes in this type of data. The frequently changing data can be identified. Eliminating this data from the working set therefore eliminates a large number of data points that have a low probability of causing application errors. Block 208 provides for comparing the persistent-state checkpoints from other machines and intersecting this with the working set to further refine the working set. For this to be useful, the other machines can include those on which the application is known to work. As in block 202 the data must contain the configuration fault. Note, however, that the set resulting from block 208 will likely be very large as two different computers will be likely to have very different configurations because of normal differences such as machine name, who uses the machine, the set of applications installed on the machine, machine address, and also because of hardware differences. Block 210 provides for using external and internal databases accessible from, for example, the Internet or other appropriate database, to rank the entries in the working set according to how likely each is to be the cause of the failure. This external data may take several forms and could be, for example, statistics collected by an application manufacturer regarding the frequency of causes of failures in an application or it may contain the occurrence of various keywords related to a given entry in the configuration data on user group forums. In block 210, pre-collected static dependency information can be used to translate the low-level, user-unfriendly configuration-data names to high-level, user-friendly notions or presentations. For example, the mapping from individual configuration-data names to the user interface programs that modify them can help point the users to appropriate places where they have a high probability of fixing the problem. It will be appreciated by one skilled in the art that a subset of these blocks can be performed and still result in effective tool to narrow the scope of configuration data that is likely to have caused the application failure.

State-Based Configuration-Failure Identification

State-based configuration failure identification can be performed using embodiments described herein for registry files, which in a Windows® Registry include multiple “hive files” that are commonly used to hold settings for applications, such as a Windows XP operating system itself. It will be appreciated by one skilled in the art that the general concepts and methods introduced herein are exemplary in nature and are applicable to many computer operating systems. The Registry plays an important role in the control and configuration of Windows-based systems. The Registry stores both machine-wide and per-user settings in a hierarchical structure similar to the one used in the file system: Registry keys are containers analogous to directories (or folders), and registry values correspond to files; Registry keys can contain sub-keys and Registry—values, and Registry values store typed data; each individual Registry keys and Registry values are identified by a unique, string-typed path name.

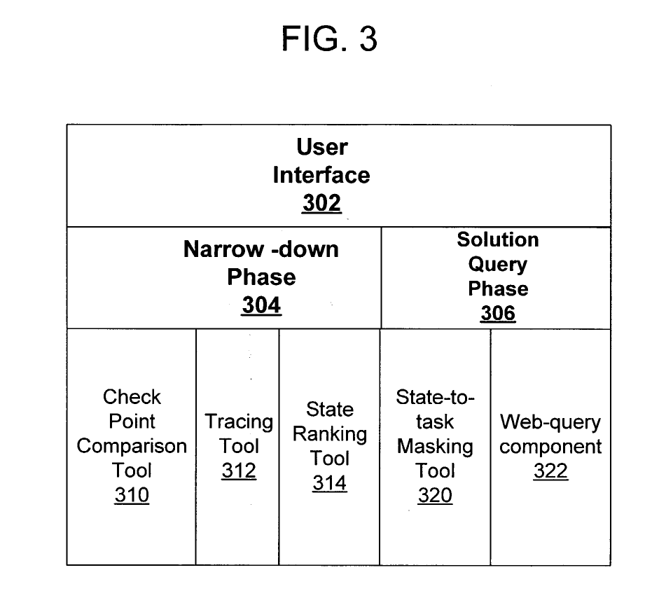

FIG. 3 illustrates the components of a state-based configuration failure detection system. The system includes a main user interface (UI) 302. The system is conceptually broken down into two phases, the narrow-down phase 304 and the solution-query phase 306. The narrow-down phase 304 further includes checkpoint comparison tool 310 for determining the diff-set between two checkpoints, the tracing tool 312 for recording registry accesses by applications, and state ranking tool 314 that keeps track of change frequencies of Registry values to determine their relative importance for troubleshooting. Solution-query phase 306 consists of a state-to-task mapping tool 320 that records UI actions of configuration tasks and their associated modifications to Registry values and a Web-query component 322 that automatically searches the online databases for related information. Each of these tools is described in further detail below.

A user typically starts the troubleshooting process by entering the main UI, which allows her to invoke the tracing tool to track failed program executions and to invoke the checkpoint comparison tool by specifying the desired date/time ranges for the two checkpoints. According to an embodiment, a method for using the system as a persistent-state configuration failure tool, herein known as the tool, is to select a time when it is known that the application in question was functional. The tool will then find a newest copy of the Registry saved prior to this date and create the diff-set between the current Registry or Registry version since a last known date of the start of a problem and this previous copy as one possible implementation of checkpoint comparison tool 310. The failure analysis tool logs all configuration data accessed from the start time to the end time as one possible implementation of tracing tool 312. The start time is chosen to be at some point in time deemed important to the execution of the failing application, for example just before the application is executed or just before the user clicks an OK button, which would then cause a dialog box to appear. The set formed by the trace tool is intersected with the diff-set to form the working set. The tool then uses the database maintained by state ranking tool 314 to score each individual Registry value in the intersection, and produces corresponding scores for each Registry value in the working set. These scores inversely rank the frequency with which each of these Registry values are changed. These rankings are used to eliminate Registry values which frequently change and have been found to store values which are unlikely to cause failures. The frequency of change can be determined by determining the fraction of the instances in which the Registry value changes between consecutive Registry checkpoints. For each Registry value that has associated UIs according to the database created by the state-to-task mapping tool 320, the tool provides links that the user can click on to replay the recorded user actions to bring up the UIs. For each Registry value with a score higher than a user-adjustable threshold, the tool provides two links to search online databases using parts of the Registry value name as the search string: one for the product-support knowledge base and the other for the online information database. The databases help to map Registry values to the programs and functions that typically modify and use these Registry values. One function of this phase is to map the Registry values to more user-friendly information. The tool also contains a Web-query component 322 to automatically perform all searches and display the numbers of matching articles to aide the troubleshooting process. Typically more problematic Registry values will show up in more articles.

Checkpoint Comparison

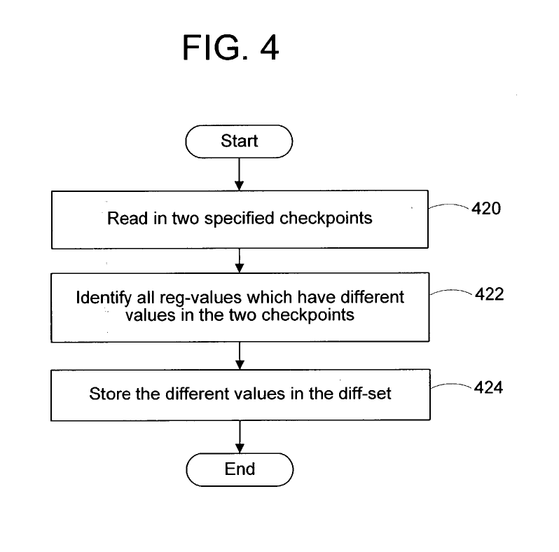

Turning to FIG. 4, the persistent states checkpoint files are created by the snapshot utility 410. In Windows XP, for example, this function is performed by the System Restore utility and can be classified into two categories: files and Registry, although the latter is ultimately stored in files as well. Registry information is a snapshot at checkpoint time. In contrast, a “snapshot” of files is achieved by using a kernel-mode file system filter driver to monitor every file operation, and saving a copy of a file away as part of the latest checkpoint before it is about to be modified for the first time after the checkpoint. When the user invokes a rollback operation, all recorded file changes since the selected checkpoint was taken are undone and then the snapshot Registry information is restored. The System Restore utility can also be configured to create persistent states checkpoint files for WMI Repository configuration, COM DB configuration and IIS Metabase configurations.

The rollback mechanism of System Restore available in most Windows operating systems can sometimes be used to repair configuration failures by rolling back all changed states without identifying which of them constitute the configuration faults. In practice, however, there are two potential problems. First, all installations of applications and drivers and all configuration tasks performed between the current time and the restored-to time will be lost. Therefore, it can be an unnecessarily expensive way of fixing a potentially minor configuration fault. Second, to avoid rolling back user documents with known “data-file extensions,” System Restore only checkpoints and restores files with extensions in a monitored file extensions list. Applications that require consistencies across files not fully covered by the list can sometimes be broken by a restore operation.

To avoid a System Restore rollback, an embodiment is directed to using a checkpoint comparison instead. The checkpoint comparison tool 310 includes three parts, checkpoint reader 420, difference unit 422, and diff-set storage 424. Checkpoint reader 420 determines and loads checkpoints into the tool. Difference unit 422 operates on the data to perform a comparison to identify the subset of configuration settings that are different between checkpoints to remove data items in the checkpoints that have the same data content in both checkpoints. Diff-set storage 424 stores the resulting set of data items. The diff set can be used directly by the user to diagnose and fix problems through localized changes whenever possible or it can be passed to later stages of the system illustrated in FIG. 3 to further limit the data set.

The checkpoint comparison tool 310 can also be used to compare checkpoints from two different machines. This is useful for determining why an application works on one computer but fails on another. While intra-machine checkpoint comparisons almost always compare the user-profile keys within the same user, cross-machine checkpoint comparisons typically involve comparing one user's information on machine A with another user's corresponding information on machine B. Therefore, this operating mode will often yield large diff-set files.

Tracing

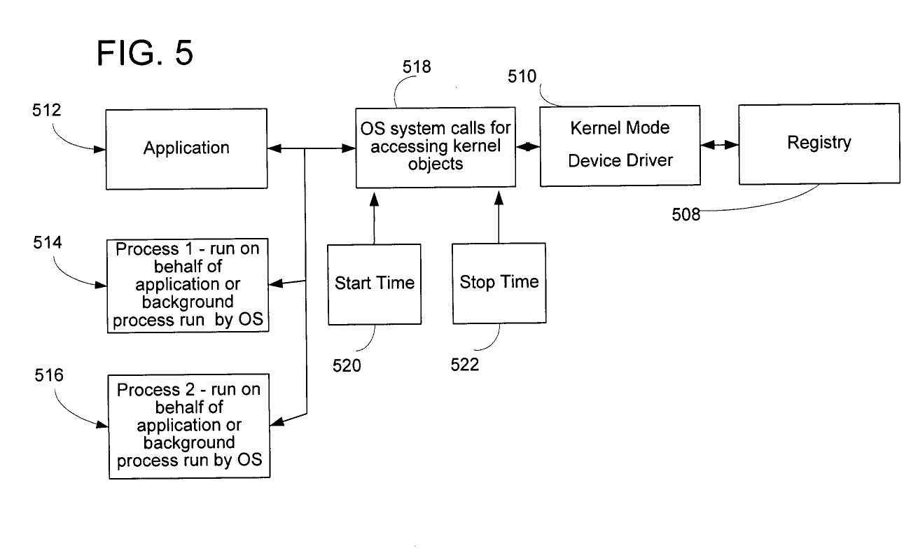

Tracing tool 312, shown in detail in FIG. 5, uses a device driver 510 to track all accesses to the registry 508. Tracing tool 312 tracks registry values accessed by application 512 and processes 514 and 516 run on behalf of application 512 or processes that are background processes that an operating system runs that interact with the application such as a security service. The tracing will begin at start time 520 and end at start time 522. The results can be logged to a log file. There is an inherent trade-off involving the amount of trace information. Collecting longer traces in general increases the chance of capturing the root-cause, but also potentially introduces more false-positives that make the root-cause harder to identify. Therefore, the “scope” of tracing, which can include which processes of the machine need to be included in the trace as well as which stages of the application execution, need to be carefully considered.

Typically, the troubleshooting process starts with using a single-executable, per-application-action trace. In this mode of operation, the tracing tool 312 will only track and log Registry accesses from application 510 and ignore those from processes 512 and 514. Start time 520 is set to a time just before the application fails and stop time 522 is set to a point shortly after the application fails. If this mode fails to capture the root-cause, the next step is to use all-executable, per-application-action trace, in which processes 512 and 514 are tracked and logged as well as application 510. Start time 520 and stop time 522 are set as above. If that is still insufficient, then the configuration fault may have been accessed only during application initialization, but have a latent effect on the target action. Therefore, a next step can include a restart of the application and collection of single-executable and all-executable, per-application-run traces with start time 520 changed to a point before the application is started.

State Ranking

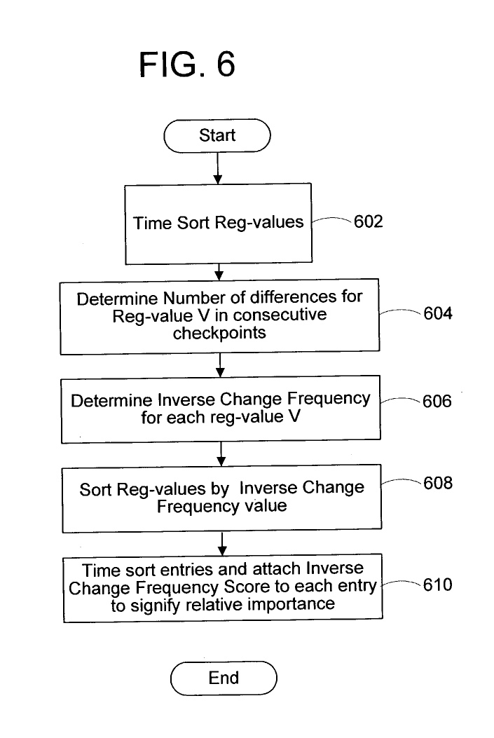

Depending on the scope of tracing, a working set may contain a large number of Registry values after the intersection of the trace and diff-set. To avoid overwhelming the users, an embodiment is directed to highlighting the values based on the ranking of the relative importance of the Registry values so that the users can prioritize their efforts. Turning to FIG. 6, two types of ranking are within the scope of this embodiment. The first is order-ranking performed in block 602. Registry values are listed in the relative order of their appearances in the trace file, where those at the top of the list are considered more important. One reason for the order of importance is that Registry values accessed earlier in the execution tend to be more critical. Once the execution diverges from the correct one, the later part of the trace becomes less useful for identifying the root-cause. Therefore, in block 602 the Registry values are sorted by the point in time in which they are accessed, with the earlier accessed values being listed first.

The second type of ranking is based on the observation that there exists a group of “active” Registry values that get updated and queried much more frequently than the others. Examples include usage counts, timestamps, window sizes and positions, cache-related information, MRU (Most Recently Used)-related information. They will more likely appear in diff-sets and are less likely be the root-causes for configuration failures. One embodiment of an algorithm that can determine the relative frequency with which Registry values are accessed is the Inverse Document Frequency (IDF) (or Inverse Change Frequency (ICF)) technique and assigning scores to registry values based on the inverse of their appearance frequency. The frequency of occurrence is based on the fraction of the instances that the Registry value changes between every pair of consecutive checkpoints. Differences are determined by block 604 which counts the number of occurrences of changes a given registry value V between pairs of consecutive pairs of checkpoints and the number of checkpoints in which V exists. Block 606 calculates the Inverse Change Frequency score for each Registry value V using the following logarithmic formulation: Inverse Change Frequency score for V=log (1+N/F_{V}), wherein N is the total number of pairs of checkpoints, i.e., the total number of diff-set documents and F_{V} is the number of documents V appears in, i.e., how many times V was changed between two consecutive checkpoints. Block 608 provides for sorting the intersection of the set of data from the tracing algorithm with the diff-set according to the Inverse Change Frequency score for each registry value V in this intersection. Block 610 provides for time sorting the entries and attaching Inverse Change Frequency score to each individual entry to help signify the relative importance of the entries.

Since the set of active Registry values depends on what software is installed, what applications are running, and the user's usage pattern of those applications, the diff-set documents need to be collected on a per-machine basis. The state ranking tool periodically checks for newly created checkpoints, invokes the checkpoint comparison tool to compare them with existing checkpoints, and updates the IDF database with the new appearance counts. Alternatively, we can use a (less effective) global, static ranking dictionary so that the users do not need to have the tool installed and running all the time.

We claim:

1. A system for determining a root cause for configuration failure of an application, the system including:
a narrow-down component configured to compare a plurality of checkpoints, each checkpoint being any configuration data saved at different points in a machine history, record configuration file accesses, and track change frequencies of configuration file values;
a solution query component coupled to the narrow-down component, the solution query component configured to record actions of the user interface and configuration file modifications and to search one or more databases for information related to the configuration failure, the solution query phase, the narrow-down component and the solution query component operative to determine a deviation from known operation of the application without requiring the application to specify configuration settings that control the deviation.

2. The system of claim 1 wherein the narrow-down component includes:
a tracing tool configured to record configuration file accesses;
a state ranking tool configured to track change frequencies, the state ranking tool determining a relative importance of tracked configuration file values; and
a checkpoint comparison tool for the comparing the checkpoints and determining a reduced set of configuration data items.

3. The system of claim 2 wherein the checkpoint comparison tool includes:
a checkpoint reader configured to load a plurality of checkpoints;
a differencing unit configured to compare and identify differences between configuration data items; and
a storage component to store a resulting set of configuration data items from the differencing unit.

4. The system of claim 2 wherein the tracing tool is configured to track all configuration file values accessed by the application and processes run on behalf of the application.

5. The system of claim 2 wherein the state ranking tool performs an order ranking, the order ranking listing a plurality of configuration file values in order of appearance.

6. The system of claim 2 wherein the state ranking tool performs an inverse change frequency ranking, the inverse change frequency ranking determining configuration file values that are frequent and unlikely to cause configuration failure.

7. The system of claim 6 wherein the frequent configuration file values are found by determining how frequently each configuration file value changes.

8. The system of claim 6 wherein the state ranking tool scores each configuration file value using log(1+N/F_{V}), wherein N represents a total number of documents representing state differences between pairs of checkpoints, and F_{V} represents a number of documents in which V appears.

9. The system of claim 8 wherein the state ranking tool sorts an intersection of a set of data from the tracing tool with the reduced set of configuration file values according to the score.

10. The system of claim 2 wherein the state ranking tool periodically checks for newly created checkpoints, invokes the checkpoint comparison tool to compare the newly created checkpoints with existing checkpoints, and updates a database with a new appearance count.

11. The system of claim 1 wherein the checkpoint is a persistent state checkpoint.

12. A method for determining a cause for failure of an application on a machine, the method comprising:
identifying a set of configuration data modified since a last known working state of an application;
intersecting the set of configuration data with a second set of configuration data including data associated with access by the application;
removing frequently changing configuration data from the intersection to provide a reduced set of configuration data; and
ranking each entry in the reduced set of configuration data by likelihood of each entry being the cause of the failure.

13. The method of claim 12 wherein the intersecting the set of configuration data with the second set of configuration data includes data associated with access by each program called by the application.

14. The method of claim 12 wherein the ranking includes tracking change frequencies and determining a relative importance of tracked configuration file values.

15. The method of claim 12 further comprising comparing the reduced set of configuration data with one or more persistent state checkpoints outside the machine.

16. The method of claim 12 wherein the intersecting is performed by a checkpoint comparison tool, the checkpoint comparison tool loading a plurality of configuration file values, comparing and removing duplicate configuration file values and storing a resulting set of configuration file values.

17. The method of claim 12 further comprising tracking all configuration file values accessed by the application and processes run on behalf of the application.

18. The method of claim 12 wherein the ranking includes an order ranking, the order ranking listing a plurality of configuration file values in order of appearance.

19. The method of claim 12 wherein the ranking includes determining configuration file values that are frequent and unlikely to cause configuration failure.

20. The method of claim 19 wherein the frequent configuration file values are found by determining a fraction of a number of configuration file value changes between each pair of consecutive checkpoints.

21. The method of claim 12 wherein the ranking includes scoring each configuration file value using log(1+N/F_{V}), wherein N represents a total number of documents representing state differences between pairs of checkpoints, and F_{V} represents a number of documents in which V appears.

22. The method of claim 12 further comprising:
periodically checking for newly created checkpoints;
comparing the newly created checkpoints with existing checkpoints; and updating a database with a new appearance count based on the comparing the newly created checkpoints.

23. A computer readable medium having computer-executable instructions to perform acts for determining a cause for failure of an application on a machine, the acts comprising:
identifying a set of configuration data modified since a last known working state of an application;
intersecting the set of configuration data with a second set of configuration data including data associated with access by the application;
removing frequently changing configuration data from the intersection to provide a reduced set of configuration data; and
ranking each entry in the reduced set of configuration data by likelihood of each entry being the cause of the failure.

24. The computer readable medium of claim 23 wherein the intersecting the set of configuration data with the second set of configuration data includes data associated with access by each program called by the application.

25. The computer readable medium of claim 23 wherein the ranking includes tracking change frequencies and determining a relative importance of tracked configuration file values.

26. The computer readable medium of claim 23 further comprising comparing the reduced set of configuration data with one or more persistent state checkpoints outside the machine.

27. The computer readable medium of claim 23 wherein the intersecting is performed by a checkpoint comparison tool, the checkpoint comparison tool loading a plurality of configuration file values, comparing a removing duplicate configuration file values and storing a resulting set of configuration file values.

28. The computer readable medium of claim 23 further comprising tracking all configuration file values accessed by the application and processes run on behalf of the application.

29. The computer readable medium of claim 23 wherein the ranking includes an order ranking, the order ranking listing a plurality of configuration file values in order of appearance.

30. The computer readable medium of claim 23 wherein the ranking includes determining configuration file values that are frequent and unlikely to cause configuration failure.
